(19) United States
(12) Patent Application Publication
(10) Pub. No.: US 2008/0250416 A1
(43) Pub. Date: Oct. 9, 2008

(54) Linking of Scheduling Systems for Appointments at Multiple Facilities

(75) Inventors: Kris Vanheede, Mortsel (BE); Henk Vansteenkiste, Mortsel (BE); Wannes Kieckens, Mortsel (BE)

Correspondence Address: HOUSTON ELISEEVA, 4 MILITIA DRIVE, SUITE 4, LEXINGTON, MA, 02421, US

(73) Assignee: QUADRAT, Mortsel (BE)

(21) Appl. No.: 11/570,657

(22) PCT Filed: Jun. 21, 2005
(86) PCT No.: PCT/EP05/52889

§ 371 Date: Jan. 12, 2007

(30) Foreign Application Priority Data
Jun. 25, 2004 (EP) 04102957.0

(51) Int. Cl. G06F 9/50

(52) U.S. Cl. 718/104

(57) ABSTRACT

Scheduling systems for scheduling appointments on multiple sites need to be linked, if such systems use different databases. The activity to be performed by the performing site during the appointment may be given by a requesting code, specific for the requesting site. If the activity can be performed at the requesting site, i.e. the requesting site and the performing site are identical, then this “requesting code” may define that one or more resources are required for performing the scheduled appointment at the requesting site. The availability of these resources can be fetched from one or more databases coupled to the requesting site. If the performing site is different from the requesting site, the requesting code used at the performing site for the activity may be different from the requesting code used at the requesting site, and different resources may be requested by the performing site. The availability of these different resources may be stored in one or more databases, different from the databases for resources at the requesting site. In the latter case, both the requesting site and the performing site keep records of the scheduled appointment e.g. in a respective database. If a person, for whom the appointment is made, is known at the requesting or performing site or both, person occupation checking may be done at either site or both.

### FIELD OF THE INVENTION

The present invention relates to linking scheduling systems, more particularly the invention relates to a system and method for linking multi-site or multi-facility appointment scheduling.

### BACKGROUND OF THE INVENTION

Medical institutes or hospitals used to operate on an independent basis. Typically such institute had a single radiology department, for which appointments need to be scheduled. If an appointment requires one or more resources, the information about the availability of these resources was available within that institute or even localised in that department.

Medical institutes now are forming clusters, where equal or similar medical examinations for a patient can be scheduled. The place where a user of a scheduling system schedules an appointment is referred to as the requesting site. If the cluster has two or more independent sites, the site for which the appointment is scheduled, i.e. the performing site, may be different from the requesting site. The scheduling system of the performing site may be different from that of the requesting site and several issues must be considered to have the requesting site scheduled the appointment at the performing site.

### SUMMARY OF THE INVENTION

The above-mentioned problems are solved by a scheduling method having the specific features set out in claim 1 and a system according to claim 6. Specific features for preferred embodiments of the invention are set out in the dependent claims.

A facility may be a physical site such as a hospital or clinic, a diagnostic centre or a treatment centre. A plurality of facilities may be organised as an organisation.

Each facility may have an associated data processing system, storing its schedule or a plurality of schedules. A schedule or scheduling information may be seen as a kind of a diary, which indicates when a resource is available and when it is not available. Availability may be refined by the mode of availability. A resource may be a medical device, a physician, a radiographer, a nurse, etc. E.g. a CT scanner may be available for examining a patient or it may be available for servicing. Similarly unavailability may be refined by the reason of its unavailability. This unavailability may be caused by the reservation or scheduling for a general, non-urgent examination on a patient; or by the reservation for a patient in a critical life situation; or by a critical maintenance program, which e.g. must be performed before any other examination on a patient is performed. A patient may also be referred to more generally as a client.

Client information may include personal data about the client or patient, such as the client's name, date of birth, social security number, payment data, address, telephone number, referring physician, diagnosis, recommended treatment. Client information may also include appointment preference data, such as the preferred time slots or periods when the client is available for an appointment. Each time slot may be identified by a date and a time period or a time frame. More generally, an available time frame for a client or patient may be identified by e.g.:
1. a starting point and an ending point; or
2. a starting point and a duration of availability.

The starting point may be identified by a date, e.g. Dec. 9, 2003 for 9 Dec. 2003, and by a start time, e.g. 15 h56 for 3 hours 56 minutes in the afternoon. Similarly, the ending point may be identified by a date, e.g. Dec. 15, 2003 and an end time e.g. 17 h00. According to this example, the available time frame is from Dec. 9, 2003 15 h56 until Dec. 15, 2003 17 h00.

The client preference data may also include a specific facility where the client would like to schedule an appointment.

A user may be the client or his representative, such as the general practitioner, a referring physician, a receptionist, a nurse, and a specialised physician. The user may be typically the person who enters the data in the requesting data processing system, being an electronic scheduling system. The user may also take knowledge of the data, e.g. scheduling data, returned by the scheduling system or both.

Further advantages and embodiments of the present invention will become apparent from the following description and the drawing.

### BRIEF DESCRIPTION OF THE DRAWINGS

FIG. 1 shows a block diagram for the method according to the current invention.

### DETAILED DESCRIPTION OF THE INVENTION

While the present invention will hereinafter be described in connection with preferred embodiments thereof, it will be understood that it is not intended to limit the invention to those embodiments. According to the present invention a scheduling system is provided to schedule appointments, which may be performed in several facilities or sites. This system allows a client, user or operator to contact really or virtually, via a computer implementation, any one of the multiple facilities of an organisation to schedule an appointment. A site may be a hospital, a diagnostic centre, a treatment centre, a private practice etc. A virtual contact may indicate that the data relating to the facility are physically stored in a data processing system that is e.g. geographically closer to the user than to the remote facility.

A user may be the referring physician, an operator at one of the facilities of the organisation, etc. The organisation may group several hospitals, treatment centres, private practices etc.

According to the present invention the multiple facilities of an organisation each may have their own data processing system with an independent database comprising the local information. The multiple facilities, according to the present invention, may be communicating with each other via a web application.

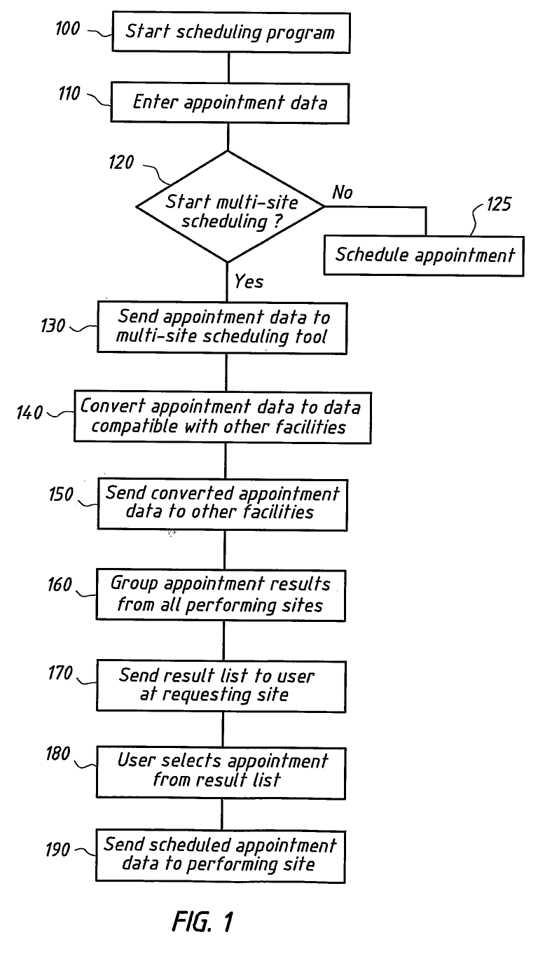

As shown in FIG. 1, in order to schedule an appointment according to the present invention, the local scheduling program is started by the user in step 100. In step 110 the user enters the appointment data by filling in the search details such as patient information, preferred period for the appointment, requested resources (room, physician, equipment, etc.). In the next step 120, the user can decide to schedule the appointment locally or to search one or more of the databases of the other facilities of the organisation and start the multi-site scheduling tool. If the user does not start multi-site scheduling, then in step 125 an ordinary scheduling process is started to schedule the appointment. If the user slects to start the multi-site scheduling tool in step 120, then in step 130 a message, comprising the search details, may be sent from the user's operating system to the multi-site scheduling tool. According to step 140 this tool may convert the search details of the user into the search terms that are used in the databases of the other facilities. If a patient requires a specific medical examination, this examination may be encoded in the requesting site according to a first exam coding scheme. The other sites, which are candidates for performing the medical examination, may have other coding schemes for identical or analogous medical examinations. According to a preferred embodiment, a central database system, preferably coupled to the planning systems of all involved sites, is keeping a mapping between examination types of one site and examination types of another site. Such mapping may look as shown in Table 1:

TABLE 1

| Code site 1 | Code site 2 | Examination type |
|---|---|---|
| skull_scan | SK_scan | Scan of skull |
| abdomen_scan | AB_scan | Scan of abdomen |
| neck_scan | NE_scan | Scan of neck |
| thorax_scan | TH_scan | Scan of thorax |

The first column of table 1 displays the examination codes used in site 1. The second column of table 1 displays the examination codes used in site 2. The third column is added here for clarity of the description and may or may not be available in the system according to the invention. The above table may be used in two senses. One sense to translate codes of site 1 to codes of site 2 and one sense to translate codes of site 2 to codes of site 1.

As long as two or a small number of sites are involved only, it is feasible to use a translation table from codes of site i to codes of site j and vice versa. However, in a preferred embodiment, the codes of any site are translated to a set of uniform codes and in a second step these uniform codes are translated to codes according to a site. These uniform codes may be
1. appointment codes according to one selected site
2. appointment codes different from those of any site in the group
3. standardised appointment codes, according to a medical standard.

To schedule an appointment originating from a requesting system to be performed on a performing system, basically the following information is required:
1. the type of the medical examination procedure, coded as an appointment code, and
2. the time window when the patient is available for that examination.

The time window for the patient may be coded as a set of availability time segments, where each time segment may specify a start time, including the date for that start and an end time, including the date for that end.

Preferably, also the identity of the patient is communicated from the requesting site to the performing site.

If the performing site is identical to the requesting site, no specific problems are encountered.

If the performing site is different from the requesting site, e.g. when the requesting site is a central organisation or a specific radiology department in a site different from the performing site, then the following actions need to be performed.

The exam code according to the requesting site is converted to the exam code of the performing site, referred to as performing code. The time window of the patient is passed from the computer system of the requesting site to the computer system of the performing site. Once the latter system receives the performing code, the performing data according to the performing code are retrieved. The performing data may include the need for performing resources, e.g. a CT scanner and a radiologist or a radiographer. It may also include the time required for the examination. Based on the availability of the required performing resources and the time window of the patient, the scheduling system running on the computer system for the performing site computes the available time segments, i.e. when the patient is available and the resources for that medical examination are simultaneously available. These available time segments are then sent to the computer system for the requesting site. The requesting site may now have at its disposal the available time segments for the requesting site, if any, and the available time segments for one or more performing sites. The user may now select among these available time segments, which may be accompanied with an identification of the performing site. Alternatively, the union of all available time segments is taken and this is presented to the user. The user can then select one available time segment for the appointment. In case the available time segment is from the union of available time segments, the system may display to the user for which performing site the solution applies. The user can then book this appointment. After booking, the performing system is informed about the time segment or start time allocated for the examination, and the availability information for the resources involved with this examination is updated, such that these resources are allocated for this examination.

Preferably, scheduling information about the examination is stored on both the requesting system and the performing system. This has the following advantages. If the requesting system is informed about an annulation of the scheduled appointment by the patient or a physician, the requesting system can retrieve the performing system on which the appointment has been scheduled. The appointment can then be deleted on the performing system too, and the required and allocated resources can be freed for other appointments. On the other hand, if due to an emergency case a required resource is not available during the time segment allocated to the patient, then the examination can be identified, including the requesting site. The user at the requesting site may then be informed about the non-availability of the resource, such that any other appropriate action may be taken.

In a preferred embodiment, both the systems at the requesting-and the performing sites may do a test on a patient availability conflict. If the requesting system sends information about the patient to the performing system, this check may be done. Information about the patient may be his unique social security number, his first name, surname and birth date. If the security information is missing, the performing system may identify the patient by the other personal data, which identification may be less accurate however.

For each of the databases, a conversion may be performed. The converted searches may be sent to the databases of the other facilities in step 150. These databases may then be searched separately and the results may be sent to the multi-site scheduling tool. In step 160 the results from the different databases may be grouped. The result list may be sent to the user without modification or the multi-site scheduling tool may select the best result, e.g. in terms of pre-defined automation criteria. The result list may be sent to the user in step 170. The user can select a suitable appointment from the result list in step 180 and may want to schedule the appointment. In step 190 a copy of the appointment may be sent to the site where the exam is to be performed. As such, both the requesting and the performing site have a record on the appointment data.

Once an appointment has been scheduled, it may be necessary to cancel that appointment or to re-schedule it. Re-scheduling an appointment may be seen as a combination of cancelling the existing appointment and scheduling a new appointment. Scheduling the new appointment may be done by using at least some of the data, limitations or constraints, used for scheduling the existing appointment. In such case, it may be sufficient to change only one data element, e.g. the time frames when the patient is available. Alternatively, all unknown and required data for the scheduling process may be entered again.

When an appointment is cancelled, it is advantageous to inform the computer systems or databases about this cancellation, such that the resources, allocated for that appointment, may be freed for the cancelled time frame.

Having described in detail preferred embodiments of the current invention, it will now be apparent to those skilled in the art that numerous modifications can be made therein without departing from the scope of the invention as defined in the appending claims.

1. A method for scheduling, according to appointment information on a requesting data processing system, an appointment for performing an activity on at least one of a plurality of facilities, coupled to a performing data processing system, said activity requiring at least one resource having resource information, said performing data processing system requiring a specific representation of appointment information, comprising the steps of:
providing said appointment information in said requesting data processing system;
transforming said appointment information according to said specific representation; and
combining, in said performing data processing system, said transformed appointment information with said resource information for generating at least one appointment.

2. The method according to claim 1 wherein:
said appointment information comprises a first coding for an examination type for said activity;
said transformed appointment information comprises a second coding for said examination type, different from said first coding;
said transforming step uses a table for transforming said first coding to said second coding.

3. The method according to claim 2, wherein said appointment information comprises time availability information for a person involved in said activity, and wherein said performing data processing system couples said second coding to said resource information and wherein said resource information comprises a duration of said activity.

4. The method according to claim 1, wherein said resource is selected from the group consisting of:
a person such as a physician, a nurse or a device operator;
equipment for performing said activity; and
a location for performing said activity.

5. The method according to claim 1, further comprising the steps of:
generating a plurality of appointment candidates;
communicating said appointment candidates to said requesting data processing system for selecting said appointment; and
selecting at least one appointment from said appointment candidates.

6. A system for scheduling, according to appointment information on a requesting data processing system, an appointment for performing an activity on at least one of a plurality of facilities, coupled to a performing data processing system, said activity requiring at least one resource having resource information, said performing data processing system requiring a specific representation of appointment information, comprising:
means for providing said appointment information in said requesting data processing system;
means for transforming said appointment information according to said specific representation; and
means for combining, in said performing data processing system, said transformed appointment information with said resource information for generating at least one appointment.

7. The system according to claim 6 wherein:
said appointment information comprises a first coding for an examination type for said activity;
said transformed appointment information comprises a second coding for said examination type, different from said first coding;
said transforming means uses a table for transforming said first coding to said second coding.

8. The system according to claim 7, wherein said appointment information comprises time availability information for a person involved in said activity, and wherein said performing data processing system couples said second coding to said resource information and wherein said resource information comprises a duration of said activity.

9. The method according to claim 1, wherein said resource is a selected one of:
a person such as a physician, a nurse or a device operator;
equipment for performing said activity; or
a location for performing said activity.
